(19) United States
(12) Patent Application Publication
(10) Pub. No.: US 2007/0103225 A1
(43) Pub. Date: May 10, 2007

(54) Charge pump circuit

(76) Inventor: Takashi Tanimoto, Motosu-gun (JP)

Correspondence Address: CANTOR COLBURN, LLP, 55 GRIFFIN ROAD SOUTH, BLOOMFIELD, CT, 06002, US

(21) Appl. No.: 11/589,412

(22) Filed: Oct. 30, 2006

(30) Foreign Application Priority Data
Nov. 4, 2005 (JP) 2005-320272

(51) Int. Cl. G05F 1/10

(52) U.S. Cl. 327/536

(57) ABSTRACT

A first charge pump circuit section generates a first voltage, and a second charge pump circuit section generates a second voltage. A drive pulse supply section includes buffer elements supplying driving pulses to switching elements in the first charge pump circuit section and the second charge pump circuit section. A charge pulse supply section generates clock pulses supplied to capacitors connected to the switching elements in the first charge pump circuit section and the second charge pump circuit section.

### CROSS-REFERENCE TO RELATED APPLICATIONS

The entire disclosure of Japanese Patent Application No. 2005-320272 including specifications, claims, drawings, and abstract is incorporated herein by references.

### BACKGROUND OF THE INVENTION

1. Field of the Invention

The present invention relates to a charge pump circuit configured to produce two (e.g., positive and negative) voltages that are different from a reference voltage.

2. Description of the Related Art

A charge pump circuit, including plural capacitors and switching elements, can be used to produce a step-up or a step-down voltage.

A conventional system includes a charge pump circuit that can produce a step-up voltage higher than a reference potential (i.e., earth potential) and another charge pump circuit that can produce a step-down voltage lower than the reference potential (i.e., earth potential). In other words, to produce both positive and negative voltages, the conventional system includes two charge pump circuits. The circuit scale of the conventional system is large, and the manufacturing cost of the conventional system is high.

Furthermore, the voltage stored in each-stage capacitor is applied, as a power source voltage, to a buffer element controlling a switching element (i.e., MOSFET) making up each stage of the charge pump circuit. Accordingly, amplitude of a pulse producible from each buffer element is small, and driving ability of each switching element (i.e., MOSFET) is small. Loss in each switching element is large. As a result, output ability of the conventional charge pump system is insufficient.

### SUMMARY OF THE INVENTION

The present invention provides a charge pump circuit configured to generate a first voltage and a second voltage which are both different from a reference potential. The charge pump circuit includes: a first charge pump circuit section including a plurality of switching elements connected to capacitors to generate the first voltage; a second charge pump circuit section including a plurality of switching elements connected to capacitors to generate the second voltage; a drive pulse supply section connected to the switching elements provided in the first charge pump circuit section and the second charge pump circuit section, and including buffer elements supplying driving pulses to drive the switching elements; and a charge pulse supply section connected to the first charge pump circuit section and the second charge pump circuit section to generate clock pulses supplied to the capacitors.

### BRIEF DESCRIPTION OF THE DRAWINGS

Preferred embodiments of the present invention will be described in detail based on the following drawings, wherein:

FIG. 1 is a schematic circuit diagram showing a first fundamental charge pump circuit;

FIG. 2 is a timing chart showing fundamental functions according to the first fundamental charge pump circuit;

FIG. 3 is a schematic circuit diagram showing a second fundamental charge pump circuit;

FIG. 4 is a timing chart showing fundamental functions according to the second fundamental charge pump circuit;

FIG. 5 is a schematic circuit diagram showing a charge pump circuit in accordance with an embodiment of the present invention; and

FIG. 6 is a timing chart showing fundamental functions of the charge pump circuit according to the embodiment of the present invention.

### DESCRIPTION OF PREFERRED EMBODIMENTS

<First Fundamental Arrangement>

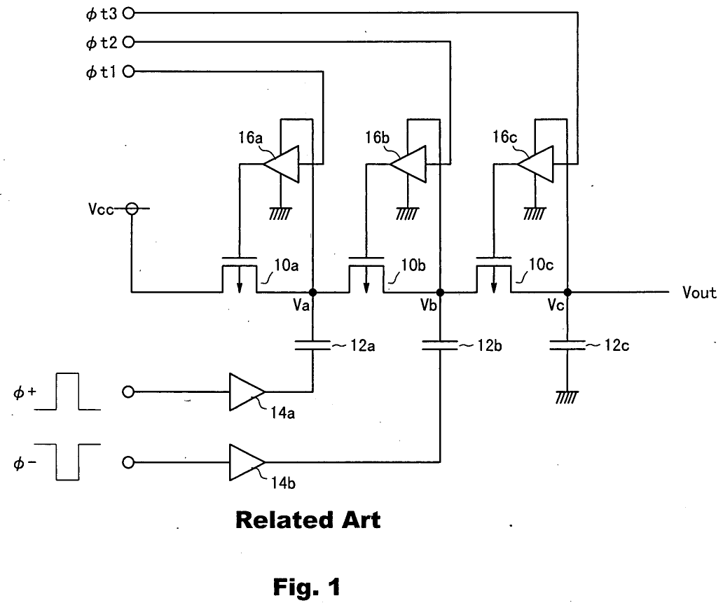

A first step-up charge pump circuit, as shown in FIG. 1, includes three switching elements 10a to 10c, three capacitors 12a to 12c, two buffer elements 14a and 14b, and three buffer elements 16a to 16c. The switching elements 10a to 10c are field-effect transistors (i.e., MOSFETs).

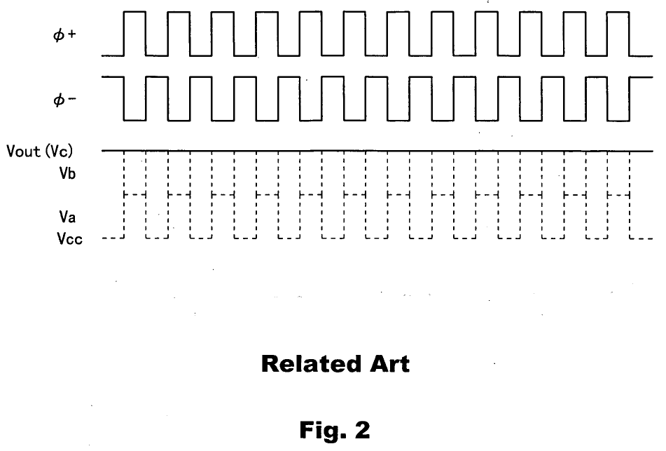

In the first step-up charge pump circuit shown in FIG. 1, clock pulses φ+ and φ− are changeable in out-of-phase to each other. When the clock pulse φ+ is in a high level, each of clock pulses φt1 and φt3 is in a high level. When the clock pulse φ+ is in a low level, each of clock pulses φt1 and φt3 is in a low level. Each of clock pulses φ+ and φ− has a pulse height equal to a voltage Vcc. Thus, as shown in FIG. 2, the voltage can be successively boosted up to voltage levels Va, Vb, and Vc. An output voltage Vout is 2Vcc higher than a power source voltage Vcc. In FIG. 2, the abscissa represents time and the ordinate represents electric potential. Voltage is high when an ordinate value is large.

<Second Fundamental Arrangement>

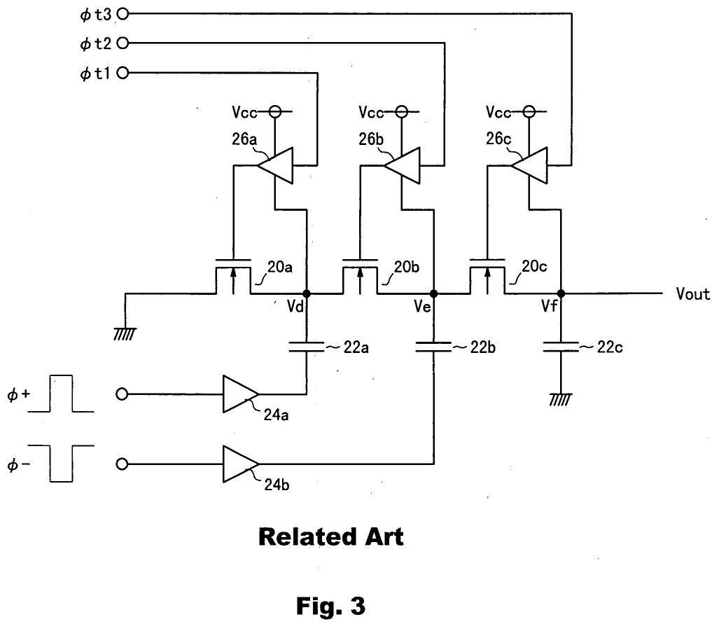

A second step-up charge pump circuit, as shown in FIG. 3, includes three switching elements 20a to 20c, three capacitors 22a to 22c, two buffer elements 24a and 24b, and three buffer elements 26a to 26c. The switching elements 20a to 20c are field-effect transistors (MOSFET).

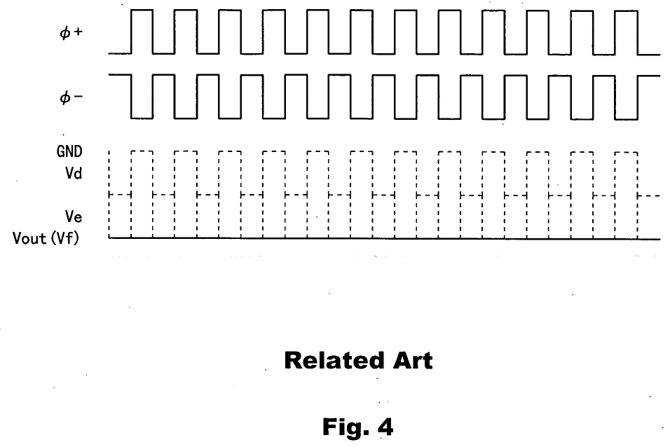

In the second step-up charge pump circuit shown in FIG. 3, clock pulses φ+ and φ− are changeable in out-of-phase to each other. When the clock pulse φ+ is in a high level, a clock pulseφt1 and φt3 are in a high level. When the clock pulse φ+ is in a low level, the clock pulseφt1 and φt3 are in a low level. Each of the clock pulses φ+ and φ− has a pulse height equal to a voltage Vcc. Thus, as shown in FIG. 4, the voltage can be successively decreased down to voltage levels of Vd, Ve, and Vf. An output voltage Vout is 2Vcc lower than a reference voltage (earth potential GND). In FIG. 4, the abscissa represents time and the ordinate represents electric potential. Voltage is high when an ordinate value is large.

### Embodiment

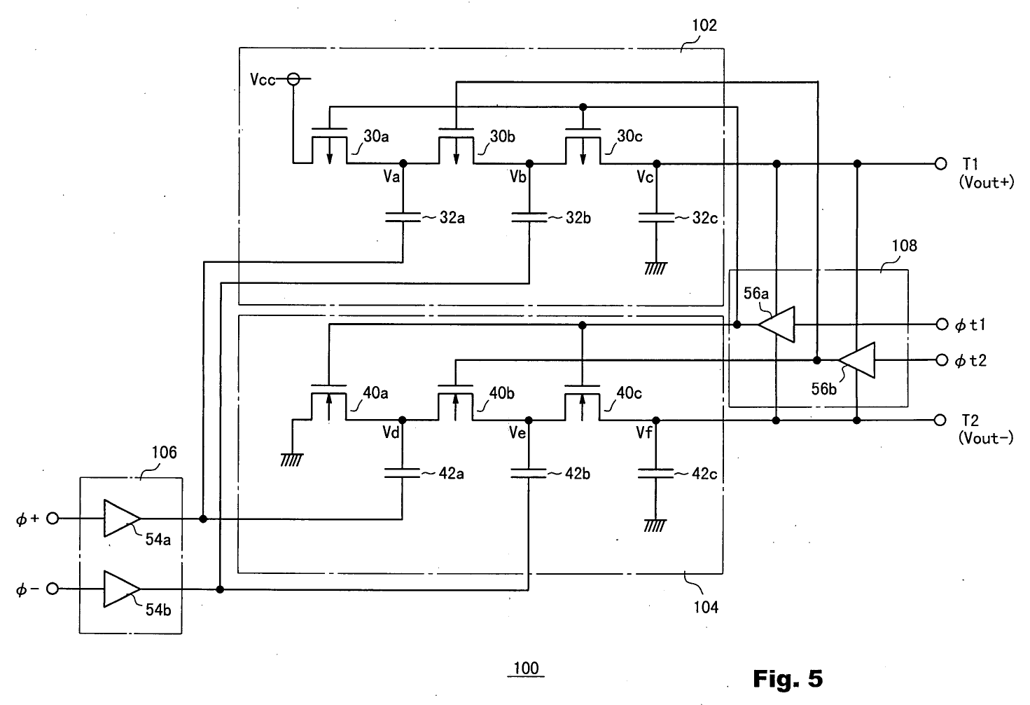

A charge pump circuit 100 according to an embodiment of the present invention, as shown in FIG. 5, includes a step-up charge pump circuit section 102, a step-down charge pump circuit section 104, a charge pulse supply section 106, and a drive pulse supply section 108.

The step-up charge pump circuit section 102 includes three field-effect transistors (MOSFETs) 30a to 30c and three capacitors 32a to 32c. The step-down charge pump circuit section 104 includes three field-effect transistors (MOSFETs) 40a to 40c and three capacitors 42a to 42c. The charge pulse supply section 106 includes two buffer elements 54a and 54b. Furthermore, the drive pulse supply section 108 includes two buffer elements 56a and 56b.

The switching elements 30a to 30c provided in the step-up charge pump circuit section 102 are P-type MOSFETs, or the like. The MOSFET 30a has a drain terminal connected to a power source and maintained at a voltage Vcc. The MOSFET 30a has a source terminal connected to a drain terminal of MOSFET 30b. The capacitor 32a has one end connected to a connecting point of the source terminal of the MOSFET 30a and the drain terminal of the MOSFET 30b. The capacitor 32a has the other end connected to an output terminal of the buffer element 54a in the charge pulse supply section 106.

The MOSFET 30b has a source terminal connected to a drain terminal of the MOSFET 30c. The capacitor 32b has one end connected to a connecting point of the source terminal of the MOSFET 30b and the drain terminal of the MOSFET 30c. The capacitor 32b has the other end connected to an output terminal of the buffer element 54b in the charge pulse supply section 106. The MOSFET 30c has a source terminal grounded via the capacitor 32c. The source terminal of the MOSFET 30c is a first output terminal T1.

The switching elements 40a to 40c provided in the step-down charge pump circuit section 104 are N-type MOSFETs, or the like. The MOSFET 40a has a drain terminal that is grounded and maintained at a reference potential (e.g., earth potential GND). The MOSFET 40a has a source terminal connected to a drain terminal of the MOSFET 40b. The capacitor 42a has one end connected to a connecting point of the source terminal of the MOSFET 40a and the drain terminal of the MOSFET 40b. The capacitor 42a has the other end connected to an output terminal of the buffer element 54a in the charge pulse supply section 106.

The MOSFET 40b has a source terminal connected to a drain terminal of the MOSFET 40c. The capacitor 42b has one end connected to a connecting point of the source terminal of the MOSFET 40b and the drain terminal of the MOSFET 40c. The capacitor 42b has the other end connected to an output terminal of the buffer element 54b in the charge pulse supply section 106. The MOSFET 40c has a source terminal grounded via the capacitor 42c. The source terminal of the MOSFET 40c is a second output terminal T2.

The buffer element 54a has an input terminal that receives a charge clock pulse φ+. The buffer element 54b has an input terminal that receives a charge clock pulse φ−. The buffer element 56a has an input terminal that receives a driving pulse φt1. The buffer element 56b has an input terminal that receives a driving pulse φt2. The driving pulses φt1 and φt2 are changeable at mutually different timing. The buffer element 56a has an output terminal connected to gate terminals of the MOSFETs 30a, 30c, 40a, and 40c. The buffer element 56b has an output terminal connected to gate terminals of the MOSFETs 30b and 40b.

Each of the buffer elements 56a and 56b has a positive power source terminal connected to the first output terminal T1 and a negative power source terminal connected to the second output terminal T2. The buffer element 56a operates under a power source voltage (i.e., output voltage Vout+) supplied from the step-up charge pump circuit section 102. The buffer element 56b operates under a power source voltage (i.e., output voltage Vout−) supplied from the step-down charge pump circuit section 104.

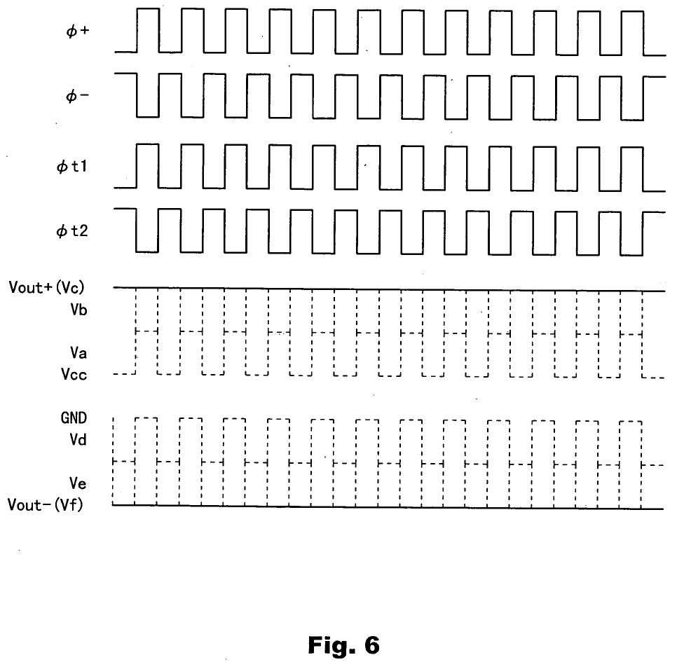

FIG. 6 is a timing chart showing fundamental functions of the charge pump circuit 100, shown in FIG. 5, according to the present embodiment. In FIG. 6, the abscissa represents time and the ordinate represents electric potential. Voltage is high when an ordinate value is large.

The clock pulse φ+ and the clock pulse φ− are changeable in mutually out-of-phase at predetermined cycles. The driving pulse φt1 and the clock pulse φ+ are changeable in phase to each other. The driving pulse φt2 and the clock pulse φ− are changeable in phase to each other. In the embodiment, the clock pulses φ+ and φ− have a pulse amplitude equal to the power source voltage Vcc.

In the step-up charge pump circuit section 102, at the timing the clock pulse φ+ become a low level and the clock pulse φ− becomes a high level, both the MOSFETs 30a and 30c are turned ON and the MOSFET 30b is turned OFF. At this point in time, one end of the capacitor 32a has a potential voltage Va equal to the power source voltage Vcc. The other end of the capacitor 32a has a potential voltage equal to a low level of the clock pulse φ+.

Next, at the timing the clock pulse φ+ becomes a high level and the clock pulse φ− becomes a low level, both the MOSFETs 30a and 30c are turned OFF and the MOSFET 30b is turned ON. As the clock pulse φ+ is in a high level, the potential voltate Va at one end of the capacitor 32a becomes a potential voltage higher than the power source voltage Vcc by an amount equal to a pulse amplitude (=Vcc) of the clock pulse φ+.

In other words, the potential voltage Va is two times higher than the power source voltage Vcc relative to the reference potential voltage (i.e., earth potential GND). As the MOSFET 30b is in an ON state, a potential voltage Vb at one end of the capacitor 32b is equal to the potential voltage Va. The other end of the capacitor 32b has a potential voltage equal to a low level of the clock pulse φ−.

Next, at the timing the clock pulse φ+ becomes a low level and the clock pulse φ− becomes a high level, both the MOSFETs 30a and 30c are turned ON and the MOSFET 30b is turned OFF. As the clock pulse φ−is in a high level, the potential voltage Vb at one end of the capacitor 32b is three times higher than the power source voltage Vcc relative to the reference potential voltage (i.e., earth potential GND). As the MOSFET 30c is in an ON state, a potential voltage Vc at one end of the capacitor 32c is equal to the potential voltage Vb. In other words, a potential voltage difference 3Vcc between the reference potential voltage (i.e., earth potential GND) and the potential voltage Vc is obtained as a first output voltage Vout+. In this manner, the step-up charge pump circuit section 102 produces a step-up voltage increased by an amount equal to the potential voltage difference 3Vcc from the reference potential voltage (i.e., earth potential GND).

In the step-down charge pump circuit section 104, at the timing the clock pulse φ+ becomes a high level and the clock pulse φ− becomes a low level, both the MOSFETs 40a and 40c are turned ON and the MOSFET 40b is turned OFF. At this point in time, one end of the capacitor 42a has a potential voltage Vd equal to the reference potential voltage (i.e., earth potential GND). The other end of the capacitor 42a has a potential voltage equal to a high level of the clock pulse φ+.

Next, at the timing the clock pulse φ+ becomes a low level and the clock pulse (φ− becomes a high level, both the MOSFETs 40a and 40c are turned OFF and the MOSFET 40b is turned ON. As the clock pulse φ+ is in a low level, the potential voltage Vd at one end of the capacitor-42a becomes a potential voltage lower than the reference potential voltage (earth potential GND) by the power source voltage Vcc.

As the MOSFET 40b is in an ON state, a potential voltage Ve at one end of the capacitor 42b is equal to the potential voltage Vd. The other end of the capacitor 42b has a potential voltage equal to a high level of the clock pulse φ−.

Next, at the timing the clock pulse φ+ becomes a high level and the clock pulse φ− becomes a low level, both the MOSFETs 40a and 40c return to the ON state and the MOSFET 40b returns to the OFF state. As the clock pulse φ− is in a low level, the potential voltage Vb at one end of the capacitor 42b has a potential voltage two times higher than the power source voltage Vcc relative to the reference potential voltage (i.e., earth potential GND).

As the MOSFET 40c is in an ON state, a potential voltage Vf at one end of the capacitor 42c is equal to the potential voltage Ve. In other words, a potential voltage lower than the reference potential voltage (i.e., earth potential GND) by a potential voltage difference 2Vcc can be obtained as a second output voltage Vout+. In this manner, the step-down charge pump circuit section 104 can produce a voltage decreased by an amount equal to the potential voltage difference 2Vcc from the reference voltage potential (i.e., earth potential GND).

According to the above-described embodiment of the present invention, the drive pulse supply section 108 producing the driving pulses φt1 and φt2 can be commonly provided for the step-up charge pump circuit section 102 and the step-down charge pump circuit section 104.

Thus, the above-described embodiment of the present invention can simplify the arrangement of the charge pump circuit 100 that is configured to produce positive and negative voltages different from the reference potential (i.e., earth potential GND). As a result, the total number of external pins required for the charge pump circuit 100 can be reduced. The manufacturing yield of the circuit can be improved, and the manufacturing cost can be reduced.

Furthermore, the above-described embodiment of the present invention can use the output voltage Vout+ and the output voltage Vout−as electric power sources for the buffer elements 56a and 56b involved in the drive pulse supply section 108. Thus, compared to the conventional system, the above-described embodiment of the present invention can change the output voltages of the buffer elements 56a and 56b in a wider range.

Accordingly, higher driving ability (current ability) can be obtained for the switching elements (i.e., MOSFETs 30a to 30c and 40a to 40c) included in the step-up charge pump circuit section 102 and the step-down charge pump circuit section 104. As a result, the loss in respective switching elements (i.e., MOSFETs 30a to 30c and 40a to 40c) can be reduced. The output efficiency of the charge pump circuit 100 can be improved.

According to the above-described embodiment, the step-up charge pump circuit section 102 and the step-down charge pump circuit section 104 are respectively arranged by a three-stage charge pump circuit including three serially connected switching elements. However, the present invention is not limited to the above-described embodiment. Thus, it is also useful to arrange a different-stage charge pump circuit.

The above-described embodiment uses the final output voltages of the step-up charge pump circuit section 102 and the step-down charge pump circuit section 104 as power source voltages of the buffer elements 56a and 56b included in the drive pulse supply section 108. It is however possible to use any intermediate charge voltages obtainable from the step-up charge pump circuit section 102 and the step-down charge pump circuit section 104 according to the required driving ability.

The above-described embodiment uses, as a combination, a step-up charge pump circuit and a step-down charge pump circuit. However, two charge pump circuits of the present embodiment can be replaced by two step-up charge pump circuits or two step-down charge pump circuits. When two voltages having the same polarity and different potentials are generated, and when a large potential difference is present between two voltages, it is useful to provide an independent charge pump circuit for each voltage so that the overall power consumption in the power source circuit can be reduced.

What is claimed is:

1. A charge pump circuit configured to generate a first voltage and a second voltage which are both different from a reference potential, the charge pump circuit comprising:
a first charge pump circuit section, connected to capacitors, including a plurality of switching elements to generate the first voltage;
a second charge pump circuit section, connected to capacitors, including a plurality of switching elements to generate the second voltage;
a drive pulse supply section connected to the switching elements provided in the first charge pump circuit section and the second charge pump circuit section, and including buffer elements supplying driving pulses to drive the switching elements; and
a charge pulse supply section connected to the first charge pump circuit section and the second charge pump circuit section through the capacitors to generate clock pulses supplied to the capacitors.

2. The charge pump circuit according to claim 1, wherein the first charge pump circuit section is a step-up charge pump circuit and the second charge pump circuit section is a step-down charge pump circuit, wherein the first voltage is a voltage higher than the reference voltage and the second voltage is lower than the reference voltage.

3. The charge pump circuit according to claim 2, wherein the first voltage higher than the reference potential and generated from the first charge pump circuit section is supplied to the buffer elements in the drive pulse supply section as voltage source, and the second voltage lower than the reference potential and generated from the second charge pump circuit section is supplied to the buffer elements in the drive pulse supply section as voltage source.
